(19) United States
(12) Patent Application Publication
(10) Pub. No.: US 2015/0015889 A1
(43) Pub. Date: Jan. 15, 2015

(54) APPARATUS AND METHOD TO IMPROVE COATINGS OF A MOVING SURFACE

(71) Applicant: Michael J. Berman, Tucson, AZ (US)

(72) Inventor: Michael J. Berman, Tucson, AZ (US)

(21) Appl. No.: 13/941,544

(22) Filed: Jul. 15, 2013

(51) Int. Cl. G01J 9/02

(52) U.S. Cl. CPC G01J 9/02
USPC 356/450

(57) ABSTRACT

A contact-free, optical measurement system determines the precision with which an article responds to a change in energy. An interferometer is used to measure the surface distortions that are caused by different amounts of energy being added to a system. In this manner, any surface distortions, or perturbations of the surface, will be detected by the interferometer measurement of the reflected light from the substrate. The degree of surface distortions of the substrate may then be readily ascertained for each level of energy input. The energy input to the system is thus optimized to result in the lowest level of distortion.

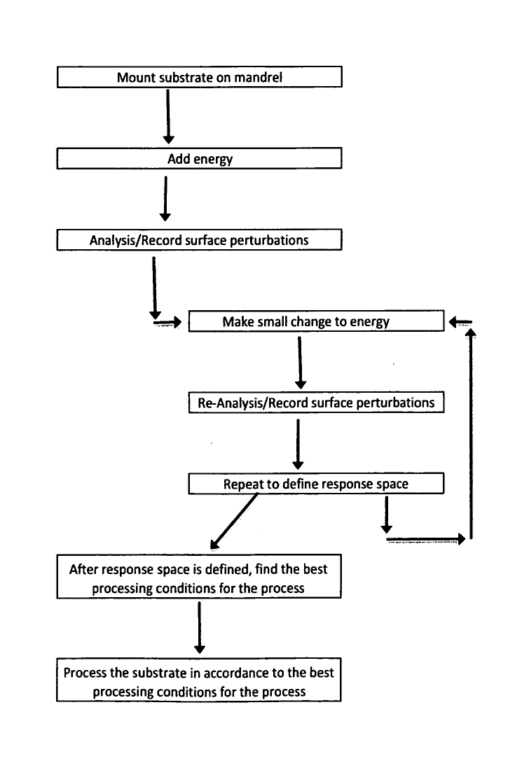

### BACKGROUND

1. Field of the Invention

A previous patent by this same inventor describes a contact-free optical measurement system for determining the precision with which an article rotates. The method described in that patent is directed at improvement of the overall performance of the process, or processes, that use rotation as a key parameter.

This patent application discloses enhancements that improve the overall process in which movement of the substrate is important. At the highest level, this patent covers analysis and feedback to a system for optimizing processing. This patent is based on measurement of the perturbation (s) to the system produced by motion of the substrate. The measurement is performed with an interferometry-type tool. The measurement will include any type of surface distortion resulting from the system in motion.

2. Description of the Invention

When energy is added to a substrate, the surface of the substrate can be distorted. This distortion can be due to a resonance occurring or misalignments in the system. This resonance can result from movement of the substrate at or near a resonance frequency. The energy can be added by motions or by a direct source of energy, heat, sunlight, direct current, sound waves radio frequency, or infrared or other wavelengths. The distortion of the surface may be a source of variability for the critical parameters of the process. This variability may result in a defect caused by missing the process goal (off-center) or a larger range of the data, such as an increase in the standard deviation of the data.

In this invention, an interferometer, such as a Fizeau Interferometer, is used to measure the distortion of the surface caused by motion or addition of energy. Also presented is a method to record and analyze the interferometer data as the substrate is moving at the speed of the process, or energy inputs to the process. With this interferometer data, an analysis of the surface distortion can be completed and used to change the motion or other inputs to the system to reduce the distortion of the surface and reduce the variability of the process.

One of the fabrication techniques used in manufacturing semiconductor wafers requires the wafer to be spun at between 3,000 and 5,000 RPMs. If there are distortions on the surface of the wafer caused by a resonant frequency of the wafer or other problems with the spinning system, the coating thickness will have a greater range and produce a lower quality product

In most cases, the value for the process (mean or range of thickness) is measured during the process or after the process, but the actions to understand causes of changes of the range cannot be controlled at this time during the process.

### SUMMARY

In one embodiment of the present invention, a Fizeau Interferometer is used to view the surface of a spinning disk, such as a semiconductor wafer, during the spinning process. The surface distortion or perturbations due to resonance frequency and other types of defects are analyzed by the interferometer without physical contact with the wafer spinning subsystem. A closed loop feedback system is used to adjust the speed or other energy inputs to reduce the distortion before subsequent processes are begun.

This system can be used on many different types of process and motions. The surface motion can be spinning, oscillating, periodic, linear, reciprocating, orbital, rotational, rolling, or any combination of two or more motions.

This invention applies to, but is not limited to, the processes of coating and removal of material. The invention applies to, but is not limited to, spin coating of a liquid or colloidal solution, and deposition by chemical vapor deposition, and physical vapor deposition. The invention applies to, but is not limited to, wet etching removal of material. The invention applies to, but is not limited to, dry etching by plasma, reactive-ion etching, and deep reactive-ion etching. The invention applies to, but is not limited to, laser etching, electron beam etching, and machining by physical contact.

The system in motion can be a 2-dimensional or 3-dimensional surface, including but not limited to the following shapes: round, disk, square, annulus, oval, lens, sphere, and ellipse.

The invention applies to improvement of a wide variety of coatings, including but not limited to spin-on dopant layers; spin-on photo resist coatings; spin-on glass coatings; sacrificial layers; MEMS layers (Micro Electro Mechanical Systems) layers; coatings used in manufacturing of hard drives and optical media; coatings used in manufacturing of photo masks for exposures by optical, extreme ultraviolet, x-ray, electrons, and ions; coatings for biological films; coatings used in manufacturing of diffraction gratings; and coatings used in manufacturing of optics.

### DETAILED DESCRIPTION

The substrate receives energy inputs, in one embodiment rotational motion, while an interferometer is used to view, measure, and analyze the perturbations of the surface. The interferometer gives real time analysis of the surface. The analysis continues as the speed of the substrate (or other inputs to the system) is changed by a small amount After the speed is changed, the data is reacquired and analyzed. Progressing though multiple iterations of increasing/decreasing changes in the input parameters within the process window, the speed at which the surface perturbations are at local minimum is found. The local minimum is the optimum speed to produce the best process.

In another embodiment of the present invention, an interferometer is used to analyze the surface of a spinning disk, such as a semiconductor wafer. After the optimal spin parameters are applied using the interferometer data, a liquid is dispensed onto the surface of the wafer. The interferometer data will ensure that the perturbations/distortions are within a set of limits that have been shown to produce results that meet the specification of the process.

### Prior Art

For Patent Application “Apparatus and Method to improve coating of a moving surface” Inventor: Michael J. Berman July 14, 2013

The search for prior art gave the following patents:

### U.S. Patent Documents

| Pat. No. | Date Issues | Inventor |
|---|---|---|
| 5,298,966 | Mar. 29, 1994 | Berman |
| 6,866,970 | Mar. 15, 2005 | Berman |
| 8,441,640 | May 14, 2013 | Patalay |
| 8,269,982 | Sep. 18, 2012 | Olczak |
| 8,253,946 | Aug. 28, 2012 | Ghislain |
| 7,206,076 | Apr. 17, 2007 | Blalock |
| 6,947,148 | Sep. 20, 2005 | Hill |
| 6,593,738 | Jul. 15, 2003 | Kesil |

The first patent by Michael J. Berman has to do with using a laser, not an interferometry tool. The '970 patent also by Michael J. Berman is detecting changes in a photo mask, not for processing of the mask, but for use to transfer a photo pattern. The Patalay and Hill patents are about measurement of work chucks or stages for holding surfaces, not the real work surface. The Olczak patent is about using a retro-reflective surface treatment on the surface of the object under measurement. The Ghislain patent is to detect molecules or other objects between two surface. The final two, Blalock and Kesil are both about measurement of the final film during and after coating.

None of the patents found cover the areas and ideas of “Apparatus and Method to improve coating of a moving surface.”What is claimed is:

1. A method for determining the distortion of a coating, said method comprising the steps of:
Injecting energy into a base on which a panel is mounted;
Affecting said coating to said panel;
Measuring a response of said coating to said energy;
Determining a distortion factor of said coating from the measured response to the said energy, said distortion factor being representative of the distortion of said coating.

2. The method of claim 1 wherein the step of injecting energy into a base on which said panel is mounted is accomplishing by rotating the said base.

3. The method of claim 1 wherein the step of determining a distortion factor is accomplished using interferometry.

4. The method of claim 1 further comprising the step of comparing said distortion factor with a standard distortion factor to thereby determine a relative distortion factor.

5. The method of claim 2 further comprising the steps of repeating the steps of claim 2 at spaced increments of rotational speed to thereby determine a plurality of distortion factors and comparing said plurality of distortion factors to thereby determine an optimal rotational speed to optimize the distortion of said coating.

6. The method of claim 5 wherein said step of inducing rotation of said base is completed at variable speed.

7. The method of claim 6 wherein a programmed electronic machine is used to complete real-time the steps of measuring a response of said panel to said rotation and determining the corresponding distortion factor, and further comprising the step of using feedback to thereby determine the optimal rotational speed to optimize the distortion of said coating.

8. The method of claim 7 wherein the said panel is a semiconductor wafer.

9. A device for optimizing the distortion of a coating on a panel, said device comprising: a means for injecting energy into a base, said base having means by which said panel is mounted to said base;
A means for affecting said coating to said panel;
A means for measuring a response of said coating to said energy;
A means for determining a distortion factor of said coating from the measured response to the said rotation, said distortion factor being representative of the distortion of said coating.

10. The device of claim 9, further comprising: a means for varying the injection of energy in response to feedback from real-time measurement of response of said coating to said energy; a programmed electronic machine used real-time to measure the response of said coating to said injection of energy and determine the corresponding distortion factor, and further use feedback to thereby determine the optimal rotational speed to optimize the distortion of said coating.

11. The device of claim 10, wherein the means for injecting energy into a base is a means for inducing rotation of a base, said base having means by which said panel is mounted to said base.

12. The device of claim 11 wherein said means for measuring a response of said coating to said energy utilizes interferometry.
